(19) United States
(12) Patent Application Publication
(10) Pub. No.: US 2024/0138401 A1
(43) Pub. Date: May 2, 2024

(54) STORAGE SYSTEM FOR CRYO-EM/ ET SAMPLES

(71) Applicant: MAX-PLANCK-GESELLSCHAFT ZUR FÖRDERUNG DER WISSENSCHAFTEN E. V., München (DE)

(72) Inventors: Stefan RAUNSER, Dortmund (DE); Sebastian TACKE, Dortmund (DE); Joachim BESLER, Dortmund (DE)

(73) Assignee: MAX-PLANCK-GESELLSCHAFT ZUR FÖRDERUNG DER WISSENSCHAFTEN E. V., München (DE)

(21) Appl. No.: 18/548,910

(22) PCT Filed: Mar. 2, 2022
(86) PCT No.: PCT/EP2022/055302

§ 371 Date: Sep. 4, 2023

(30) Foreign Application Priority Data
Mar. 2, 2021 (EP) 21160357.6

(51) Int. Cl. A01N 1/02; G01N 1/42

(52) U.S. Cl. CPC A01N 1/0284; A01N 1/0257; A01N 1/0268; G01N 1/42

(57) ABSTRACT

The present invention relates to a storage device (1) for storing cryogenic samples (2), comprising at least one sample holder (3), the sample holder being configured to hold at least one cryogenic sample (2). According to the present invention, the storage device (1) further comprises an elongated sample transport unit (4) configured to releasably hold the at least one sample holder (3) and to be inserted into an internal space (50) of a cryogenic storage dewar (5) through an opening (51) of the cryogenic storage dewar to completely submerge the sample transport unit into a cryogenic liquid (6) residing in the internal space, wherein the sample transport unit is further configured to move said at least one sample holder along a predefined path from a storage position into a removal position, from which the at least one sample holder can be removed from the internal space of the cryogenic storage dewar. The sample transport unit may comprise a chain (40) to be circulated to move the sample holder along said pre-defined path, the chain being looped around a first and a second toothed wheel (41,42).

The present invention relates to a storage device for storing cryogenic samples. Furthermore, the invention relates to a method for storing cryogenic samples using such a storage device.

After vitrification, cryogenic samples such as cryo-EM/ET samples need to be stored at cryogenic conditions (−196° C.) to avoid de-vitrification. Typically, samples are prepared on EM-grids, which are stored in small grid boxes. These boxes are then stored either in Falcon tubes or puck systems. Both systems are not optimal since either the strings of the Falcon tubes are entangled or the entire system needs to be removed from the dewar (puck systems). If Falcon tubes are utilized for storage, an easy access of the sample material is almost impossible. Moreover, it is difficult to realize an adequate organization of the sample material and automation is impossible. If a puck system is used, the organization of the sample material is possible, but the entire canister needs to be removed to access the sample material. This leads to frost contamination of the sample material.

Based on the above, the problem to be solved by the present invention is to provide a storage device and a method for storing cryogenic samples that are improved regarding the above-stated difficulties.

This problem is solved by a storage device having the features of claim 1 and a method having the features of claim 15.

Preferred embodiments of these aspects of the present invention are stated in the sub claims and are described below.

According to claim 1, a storage device for storing cryogenic samples is disclosed, comprising:
at least one sample holder, the sample holder being configured to hold at least one cryogenic sample.

According to the invention, the storage device further comprises an elongated sample transport unit configured to releasably hold the at least one sample holder and to be inserted into an internal space of a cryogenic storage dewar through an opening of the cryogenic storage dewar to completely submerge the sample transport unit into a cryogenic liquid (e.g. liquid nitrogen) residing in the internal space, wherein the sample transport unit is further configured to move said at least one sample holder along a pre-defined path from a storage position into a removal position, from which the at least one sample holder can be removed from the internal space of the cryogenic storage dewar.

Preferably, said path is a closed path so that the at least one sample holder can be moved along the closed path starting from its storing position back to its storing position.

Furthermore, according to an embodiment, the removal position of the at least one sample holder (particularly of any sample holder of the storage device) is a topmost position of the respective sample holder when being held by the sample transport unit, wherein particularly the sample transport unit is configured to be inserted into the internal space of the cryogenic storage dewar such that the respective sample holder is fully submerged in the cryogenic liquid even when residing in the removal position. In other words, the sample transport unit is designed such that it can be completely inserted into the internal space of the cryogenic storage dewar in a way that each sample holder is always positioned below a level of the cryogenic liquid filled into said internal space.

The storage device according to the present invention thus overcomes the limitations/imperfections of the currently available storage systems described above that have a high risk of either entangling of the strings by means of which the samples in the Falcon tubes are suspended in the cryogenic liquid or require removing a large number of samples from the cryogenic liquid although only a specific sample is needed.

Furthermore, according to an embodiment of the storage device, the sample transport unit comprises a chain configured to be circulated to move the at least one sample holder along said pre-defined path.

Preferably, in an embodiment, the chain is looped around and meshing a first and a second toothed wheel, the first and the second toothed wheel being arranged opposite one another.

Particularly, for circulating the chain, the sample transport unit comprises a gear configured to drive the first toothed wheel.

According to an embodiment, the gear comprises a rotatable drive shaft coupled to a rotatable output shaft, the output shaft being coupled to the first toothed wheel and the drive shaft comprising an end section configured to releasably engage with a rotatable shaft (e.g. of an actuator) to circulate the chain by rotating the drive shaft of the gear and therewith the output shaft and the first toothed wheel.

Furthermore, according to an embodiment, the drive shaft is aligned with the vertical and the output shaft is aligned with the horizontal when the sample transport unit is inserted in the internal space of the cryogen storage dewar as intended.

According to a further embodiment of the storage device, the at least one sample holder is configured to be releasably connected to the chain by means of a fastener. Particularly, according to an embodiment, the fastener comprises a permanent magnet generating a magnetic force fastening the at least one sample holder to the chain in a releasable fashion.

According to a further embodiment, the at least one sample holder comprises a container configured to receive a plurality of boxes, each box being configured to hold at least one cryogenic sample, wherein particularly the at least one cryogenic sample is a substance arranged on a grid. Particularly, the sample is cryo-EM/ET sample prepared on an EM-grid, wherein cryo-EM stands for cryo-electron microscopy and cryo-ET for cryo-electron tomography. Preferably, in an embodiment, the at least one sample holder comprises a lid configured to close the container.

According to yet another embodiment, the container comprises a screw configured to releasably fasten the lid to the container, wherein particularly the screw comprises a head comprising a circumferential groove formed in the periphery of the head to allow engaging the head with a tool to remove the respective container from the sample transport unit when the sample is in the removal position.

Particularly, according to an embodiment, the lid comprises through holes, each through hole allowing a portion of a box accommodated by the container to protrude out of the at least one sample holder thus allowing direct contact between the boxes and the cryogenic liquid in the internal space of the cryogenic storage dewar.

According to a further embodiment, the storage device further comprises an elongated retainer connected to the sample transport unit and configured to protrude out of the internal space of the cryogenic storage dewar through said opening to hold the sample transport unit when the sample transport unit is inserted into the internal space of the cryogenic storage dewar to submerge the sample transport unit in said cryogenic liquid residing in the internal space of the cryogenic storage dewar. Particularly, the retainer comprises a first end section being connected to the sample transport unit and an opposite second end section forming a hook for hanging the sample transport unit (e.g. from the cryogenic storage dewar) when the sample transport unit is arranged in the internal space of the cryogenic storage dewar.

According to a further embodiment, the storage device comprises a plurality of sample holders, wherein the respective sample holder can be configured as described above with respect to the at least one sample holder.

Particularly, the sample transport unit is configured to releasably hold said plurality of sample holders and to be inserted into the internal space of the cryogenic storage dewar through the opening of the cryogenic storage dewar to completely submerge the sample transport unit into a cryogenic liquid residing in the internal space, wherein the sample transport unit is further configured to move said plurality of sample holders along a pre-defined path, so that each sample holder of said plurality of sample holders can be moved from a storage position into a removal position, from which the respective sample holder can be removed from the internal space of the cryogenic storage dewar.

Particularly, each sample holder is configured to be releasably connected to the chain by means of a fastener such that the sample holders are arranged side by side along the chain. The respective fastener can be designed as described above.

Furthermore, according to an aspect of the present invention, a system is disclosed, the system comprising a storage device according to the present invention and a cryogenic storage dewar.

According to an embodiment of the system, the cryogenic storage dewar comprises an internal space. Furthermore, according to an embodiment of the system, the system comprises a cryogenic liquid residing in the internal space, wherein the elongated sample transport unit is inserted into the internal space through an opening of the cryogenic storage dewar and is completely submerged into the cryogenic liquid residing in the internal space. Preferably, in an embodiment of the system, the sample transport unit is configured to move said at least one sample holder along a pre-defined path from a storage position into a removal position, from which the at least one sample holder can be removed from the internal space of the cryogenic storage dewar.

Preferably, in an embodiment of the system, the removal position of the at least one sample holder (particularly of any sample holder of the storage device) is a topmost position of the at least one sample holder when being held by the sample transport unit, wherein preferably the at least one sample holder is fully submerged in the cryogenic liquid even when residing in the removal position.

Yet another aspect of the present invention relates to a method for storing cryogenic samples using a storage device according to the present invention, the sample transport unit being submerged in a cryogenic liquid residing in an internal space of a cryogenic storage dewar, the method further comprising the steps of:
causing the sample transport unit to move a sample holder holding at least one cryogenic sample from a storage position of the sample holder to a removal position of the sample holder,
removing the sample holder from the sample transport unit and the cryogenic liquid residing in the internal space of the cryogenic storage dewar when the sample holder resides in the removal position.

According to an embodiment of the method, the step of causing the sample transport to move the sample holder holding at least one cryogenic sample from a storage position of the sample holder to a removal position of the sample holder comprises inserting a rotatable shaft through the opening of the cryogenic storage dewar into the internal space of the cryogenic storage dewar such that it engages with said end section of the drive shaft and rotating the rotatable shaft causing the chain to circulate to move the sample holder being connected to the chain from the storage position to the removal position.

Particularly, the rotatable shaft can be rotated e.g. by an actuator, particularly a tool such as a cordless screwdriver.

In an embodiment, the rotatable shaft or the actuator is operated manually by a person. According to an alternative embodiment, the drive shaft or rotatable shaft is rotated by a robot device.

Furthermore, according to an embodiment, when the sample holder is in the removal position, the sample holder is removed from the sample transport unit and the internal space and cryogenic liquid therein by engaging with a tool into the groove of the head of the screw of the sample holder and lifting the tool upwards. Particularly, when residing in the removal position, the respective sample holder is fully submerged in the cryogenic liquid (see also above).

Particularly, in an embodiment, the tool can be manually engaged with the groove and can be manually lifted upwards by a person. According to an alternative embodiment the tool can be engaged with the groove and can be lifted upwards by means of a robot device.

Further features and advantages of the present invention as well as embodiments of the present invention shall be described in the following with reference to the Figures, wherein

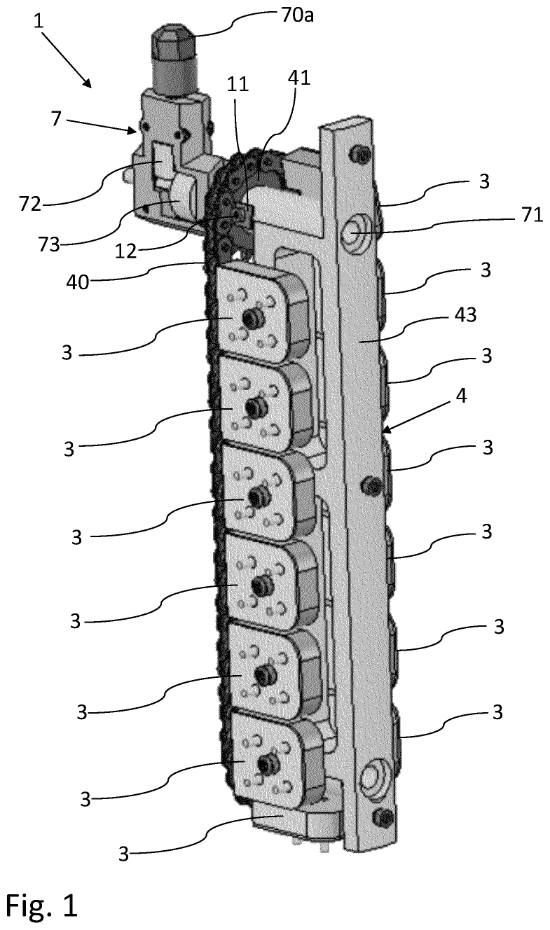

FIG. 1 shows a perspective view of a sample transport unit of an embodiment of a storage device according to the present invention;

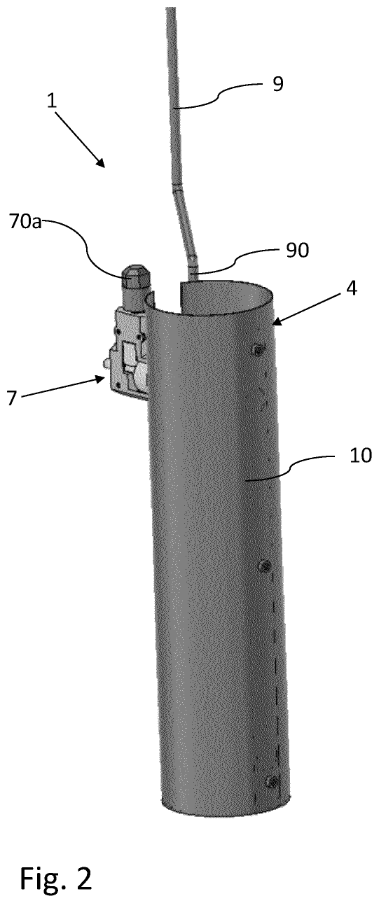

FIG. 2 shows a further perspective view of the sample transport unit of FIG. 2;

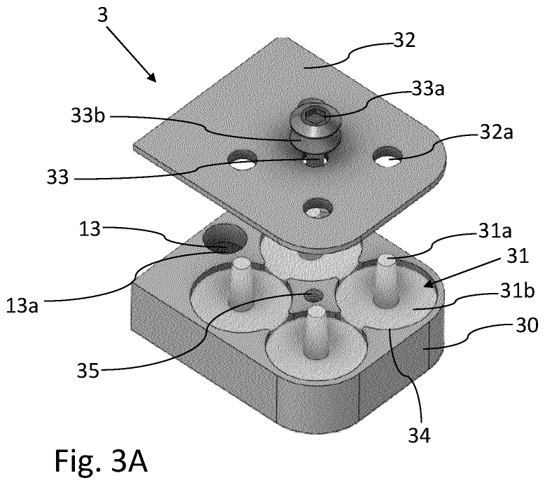

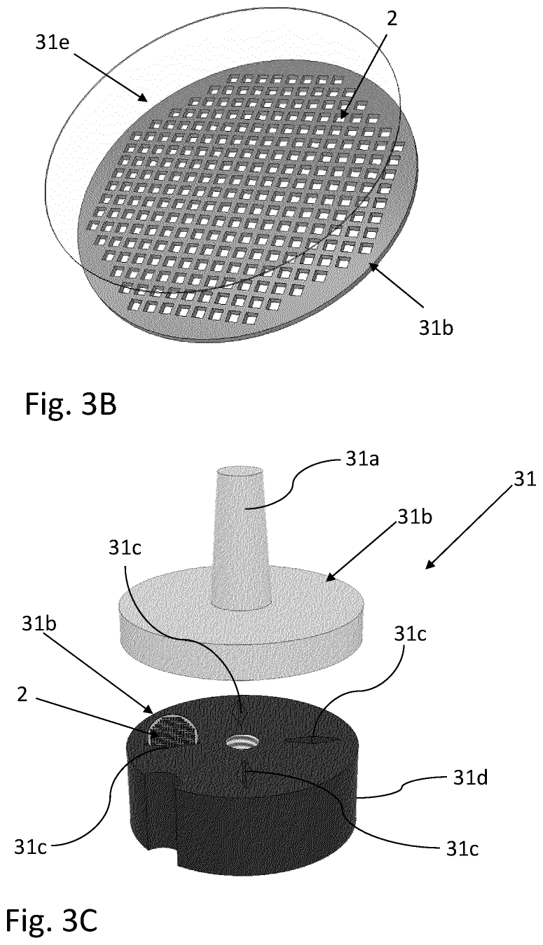

FIG. 3A shows a sample holder connectable and transportable by the sample transport unit shown in FIGS. 1 and 2;

FIG. 3B shows a perspective view of a cryogenic sample prepared on a grid;

FIG. 3C shows a box for holding cryogenic samples;

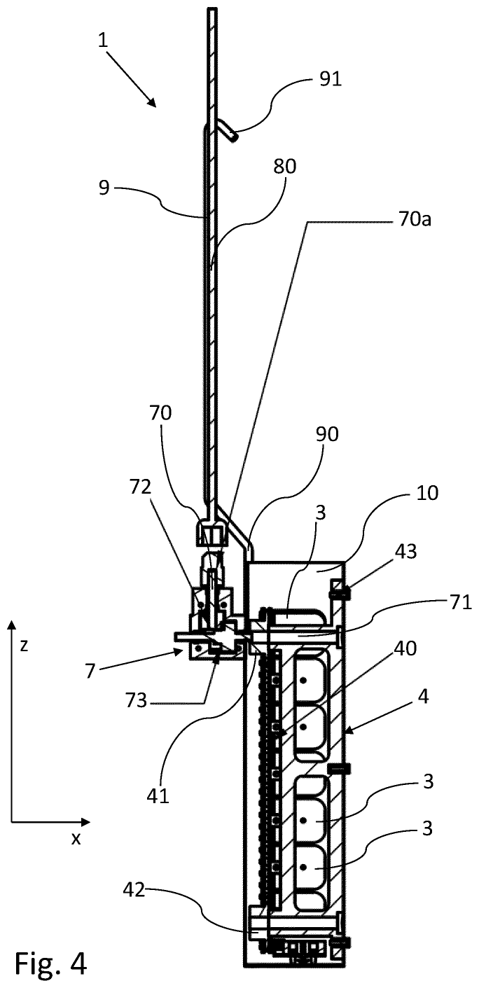

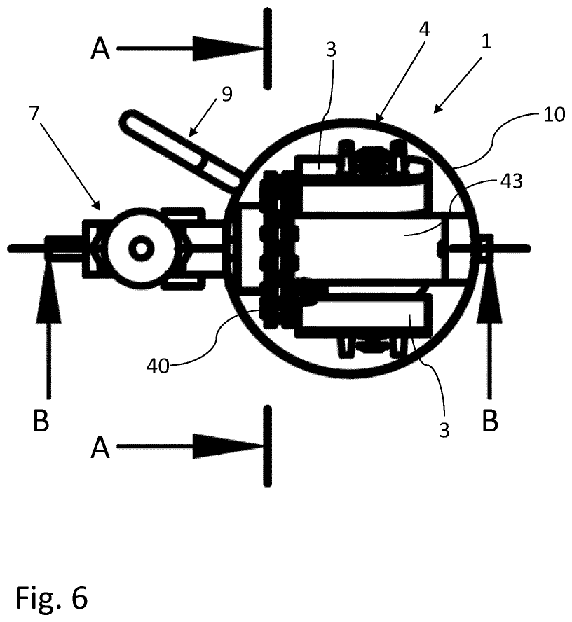

FIG. 4 shows a cross-sectional view of the storage device along the plane B-B of FIG. 6;

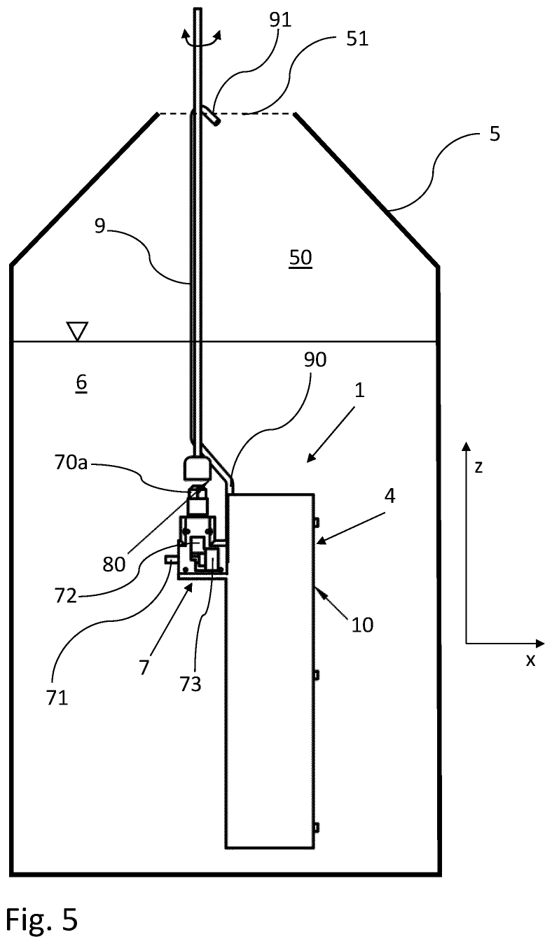

FIG. 5 shows a side view of the storage device with the sample transport unit being inserted into an internal space of a cryogenic storage dewar;

FIG. 6 shows a top view onto the sample transport unit; and

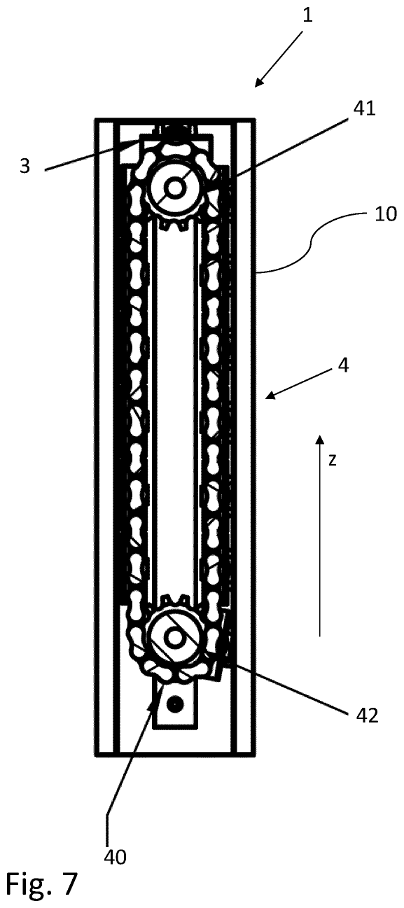

FIG. 7 shows a view in the direction A of FIG. 6 onto the sample transport unit.

FIGS. 1, 2 and 3A to 3C show an embodiment of a storage device 1 for storing cryogenic samples 2 according to the present invention. According thereto, the storage device 1 comprises a plurality of sample holders 3 as shown in FIG. 3A being configured to hold at least one cryogenic sample 2 (cf. FIG. 3C) and an elongated sample transport unit 4 aligned with the vertical z when being inserted into an internal space 50 of a cryogenic storage dewar 5 through an opening 51 of the dewar 5 (cf. FIG. 5), wherein the sample holders 3 are configured to be releasably connected to the sample transport unit 4.

Furthermore, the sample transport unit 4 is configured to transport each sample holder 3 along a pre-defined path from a storage position into a removal position, from which the desired sample holder 3 can be removed from the internal space 50 of the cryogenic storage dewar 5. Preferably, said path is a closed path so that the sample holders 3 can be collectively moved along the closed path whereby each sample holder 3 can be moved from its respective storing position to a removal position which is the topmost position. In case a specific sample holder 3 shall not be removed it can be moved past the removal position and particularly back to its original storing position. Particularly, even in the topmost removable position, each sample holder 3 can be fully submerged in the cryogenic liquid 6 residing in the internal space 50 of the dewar 5 (cf. FIG. 5).

Further, the sample transport unit 4 can be enclosed by a cylindrical shroud 10 as indicated in FIG. 2.

Particularly, as shown in FIGS. 4, 6 and 7, the transport of the sample holders 3 and the cryogenic samples 2 therein can be realized by means of a chain 40 that is looped around an upper first toothed wheel 41 and a lower second toothed wheel 42 that are both supported in a rotatable fashion on a frame 43 of the sample transport unit 4.

Due to the circular motion of the sample holders 3 that allow to move a specific sample holder 3 into a removal position, the sample holders 3 can always stay submerged in the cryogenic liquid 6 and only loose contact to the cryogenic liquid once they are eventually removed from the sample transport unit 4/dewar 5. The storage device 1 therefore allows to overcome the drawbacks of current solutions. Furthermore, the cryogenic storage dewar 5 does not need to be a special purpose dewar but can be a standard sample canister already available on the market.

Furthermore, each sample holder 3 is preferably formed as shown in FIG. 3A. According thereto, the respective sample holder 3 comprises a container 30 that can be formed out of suitable metal such as a stainless steel, aluminium, copper, or brass. The container 30 is configured to receive a plurality of boxes 31, particularly four boxes 31, each box 31 being configured to hold at least one cryogenic sample 2, particularly four such samples 2 (cf. FIGS. 3B and 3C), wherein particularly the respective cryogenic sample 2 is a substance prepared on a grid 31b (e.g. a cryo-EM/ET sample 2 prepared on an EM-grid 31b). Particularly, the grid 31b can comprise or can be formed out of an amorphous carbon or gold film 31e. The film 31e serves as support layer for the cells/proteins forming the sample 2.

Furthermore, each box 31 comprises a container portion 31d comprising a recess 31c (e.g. in form of a slot) for each grid 31b/sample 2 for accommodating the respective grid 31b/sample 2. The container portion 31d can be closed by a lid portion 31b of the box 31. The lid portion 31b preferably comprises a protrusion 31a that can also be used as a handle for manually removing the lid portion 31b from the container portion 31d of the respective box 31.

For accommodating the respective box 31, the container 30 can comprise a corresponding number of recesses 34, such that the respective box 31 can be inserted in a form-fitting manner into an associated recess 34. The individual recesses 34 can be connected to one another. Furthermore, the respective sample holder 3 comprises a lid 32 configured to close the container 30 to secure the boxes 31 therein. In order to fasten the lid 32 to the container 30 the sample holder 3 preferably comprises a screw 33 configured to releasably fasten the lid 32 to the container 30 by being screwed through the lid 32 into a threaded bore 35 of the container 30. Particularly, the screw 33 comprises a head 33a comprising a circumferential groove 33b formed into the periphery of the head 33a. This groove 33b can be engaged by a tool to remove the sample holder 3 from the sample transport unit 4 when the sample holder 3 resides in its removal position.

Furthermore, the lid 32 can comprises through holes 32a for each of the boxes 31 so that the protruding portion 31a of the respective box 31 can protrude out of the sample holder 3 to allow contact of the boxes 31 to the cryogenic liquid 6. Since each box 31 can be labeled with a bar code, the sample storage according to the present invention offers the possibility to remove sample holders 3 automatically (e.g. by a robot device).

The respective sample holder 3 can be releasably connected to the chain 40 by means of a fastener 11. Particularly, the fastener 11 comprises a permanent magnet 12 generating a magnetic force that acts on a permanent magnet 13 connected to the sample holder 3. Particularly, the permanent magnet 13 of the sample holder 3 can be arranged in a corresponding opening 13a of the holder 3 (cf. FIG. 3A). Due to this attractive force, the respective sample holder 3 can be fastened to the chain 40 in a releasable fashion. Particularly, the respective fastener 11 can be connected to the chain 40 and protrude therefrom so that the respective sample holder 3 can be arranged thereon and can be fixed to the fastener 11/chain 40 by means of the magnetic forces between said permanent magnets 12, 13 (cf. FIGS. 1 and 3A).

To actually circulate the chain 40 to move the sample holders 3 to the removal position, the sample transport unit 4 comprises a gear 7 configured to drive the first toothed wheel 41 as shown in FIG. 4. Particularly, the gear 7 comprises a rotatable drive shaft 70 coupled to a rotatable output shaft 71. For this, the drive shaft 70 can comprise a toothed wheel 72 meshing with a toothed wheel 73 provided on the output shaft 71, such that the drive shaft 70 is aligned with the vertical z and the output shaft 71 is aligned with the horizontal x (cf. FIG. 4). This allows easy access to the drive shaft 70 by means of a rotatable shaft 80 that reaches into the internal space 50 of the dewar 5 from the outside and can be driven from the outside by means of a suitable tool (or even by hand). The rotatable shaft 80 can engage with an end section 70a of the drive shaft 70 so that rotation of the shaft 80 causes rotation of the first toothed wheel 41 being coupled to the output shaft 71 and therewith circulation of the chain 40.

Furthermore, as shown in FIG. 5, the storage device 1 can be suspended from the dewar 4 into the internal space 50 using an elongated retainer 9 connected to the sample transport unit 4, particularly to the shroud 10. Particularly, the retainer 9 comprises a first end section 90 being connected to the shroud 10 and an opposite second end section 91 forming a hook for hanging the sample transport unit 4 from the dewar 5 when the sample transport unit 4 is arranged in the internal space 50 of the cryogenic storage dewar 5.

1. A storage device (1) for storing cryogenic samples (2), comprising:
at least one sample holder (3), the sample holder (3) being configured to hold at least one cryogenic sample (2),
characterized in that
the storage device (1) further comprises an elongated sample transport unit (4) configured to hold the at least one sample holder (3) and to be inserted into an internal space (50) of a cryogenic storage dewar (5) through an opening (51) of the cryogenic storage dewar (5) to completely submerge the sample transport unit (4) into a cryogenic liquid (6) residing in the internal space (50), wherein the sample transport (4) unit is further configured to move said at least one sample holder (3) along a pre-defined path from a storage position into a removal position, from which the at least one sample holder (3) can be removed from the internal space (50) of the cryogenic storage dewar (5).

2. The storage device according to claim 1, wherein the sample transport unit (4) comprises a chain (40) configured to be circulated to move the at least one sample holder (3) along said pre-defined path.

3. The storage device according to claim 2, wherein the chain (40) is looped around a first and a second toothed wheel (41, 42), the first and the second toothed wheel (41, 42) being arranged opposite one another.

4. The storage device according to claim 2, wherein for circulating the chain (40), the sample transport unit (4) comprises a gear (7) configured to drive the first toothed wheel (41).

5. The storage device according to claim 4, wherein the gear (7) comprises a rotatable drive shaft (70) coupled to a rotatable output shaft (71), the output shaft (71) being coupled to the first toothed wheel (41) and the drive shaft (70) comprising an end section (70a) configured to releasably engage with a rotatable shaft (80) of an actuator to circulate the chain (40) by rotating the drive shaft (70) of the gear (7) and therewith the output shaft (71) and the first toothed wheel (41).

6. The storage device according to claim 5, wherein the drive shaft (70) is aligned with the vertical (z) and the output shaft (71) is aligned with the horizontal (x) when the sample transport unit (4) is inserted in the internal space (50) of the cryogen storage dewar (5).

7. The storage device according to claim 1, wherein the at least one sample holder (3) is configured to be releasably connected to the chain (40) by means of a fastener (11).

8. The storage device according to claim 7, wherein the fastener (11) comprises a permanent magnet (12) configured to attract a permanent magnet (13) comprised by the at least one sample holder (3) for fastening the at least one sample holder (3) to the chain (40) in a releasable fashion.

9. The storage device according to claim 7 or 8, wherein the at least one sample holder (3) comprises a container (30) configured to receive a plurality of boxes (31), each box (31) being configured to hold at least one cryogenic sample (2), wherein particularly the at least one cryogenic sample (2) is a substance prepared on a grid (31b).

10. The storage device according to claim 9, wherein the at least one sample holder (3) comprises a lid (32) configured to close the container (30).

11. The storage device according to claim 10, wherein the at least one sample holder (3) comprises a screw (33) configured to releasably fasten the lid (32) to the container (30), wherein particularly the screw (33) comprises a head (33a) comprising a circumferential groove (33b) formed in the periphery of the head (33a) to allow engaging the head (33a) with a tool to remove the sample holder (30) from the sample transport unit when the sample holder (3) is in the removal position.

12. The storage device according to claim 10 or 11, wherein the lid (32) comprises through holes (32a), each through hole (32a) allowing a portion (31a) of a box (31) accommodated by the container (30) to protrude out of the at least one sample holder (3).

13. The storage device according to claim 1, wherein the storage device (1) further comprises an elongated retainer (9) connected to the sample transport unit (4) and configured to hold the sample transport unit (4) when the sample transport unit (4) is inserted into the internal space (50) of the cryogenic storage dewar (5) to submerge the sample transport unit (4) in said cryogenic liquid (6) residing in the internal space (50) of the cryogenic storage dewar (5).

14. The storage device according to claim 13, wherein the retainer (9) comprises a first end section (90) being connected to the sample transport unit (4) and an opposite second end section (91) forming a hook for hanging the sample transport unit (4).

15. Method for storing cryogenic samples (2) using a storage device (1) according to claim 1, the sample transport unit (4) being submerged in a cryogenic liquid (6) residing in an internal space (50) of a cryogenic storage dewar (5), the method further comprising the steps of:
causing the sample transport unit (4) to move a sample holder (3) holding at least one cryogenic sample (2) from a storage position of the sample holder (3) to a removal position of the sample holder (3), and
removing the sample holder (3) from the sample transport unit (4) and the cryogenic liquid (6) residing in the internal space (50) of the cryogenic storage dewar (5) when the sample holder (3) resides in the removal position.
